(19) United States
(12) Patent Application Publication
(10) Pub. No.: US 2013/0303322 A1
(43) Pub. Date: Nov. 14, 2013

(54) Variable Speed Drive System

(71) Applicant: ROBERT C. KENNEDY, GREENVILLE, SC (US)

(72) Inventor: ROBERT C. KENNEDY, GREENVILLE, SC (US)

(21) Appl. No.: 13/889,120

(22) Filed: May 7, 2013

Related U.S. Application Data
(60) Provisional application No. 61/643,981, filed on May 8, 2012.

(51) Int. Cl. F16H 3/72

(52) U.S. Cl. CPC F16H 3/725
USPC 475/149

(57) ABSTRACT

An electronically controlled variable speed mechanical drive to be used in high power applications where using a direct drive motor is not feasible due to weight and size constraints. The variable speed drive components convert an externally driven fixed displacement pump into a variable displacement pump by electronically setting the pump speed to meet flow demands. A single stage pump and a multi-stage pump are so converted according to the present disclosure.

### REFERENCE TO PROVISIONAL APPLICATION

The benefit of priority of Provisional Application No. 61/643,981, filed May 8, 2012, is hereby claimed.

### FIELD OF THE INVENTION

The present invention relates generally to an electronically controlled variable speed drive and pertains particularly to aircraft pumps. The disclosed pump drive can transform a fixed displacement pump into a variable displacement pump so that flow on demand can be achieved. It can be coupled to either a single or a two stage fixed displacement pump and is intended to be used in high horsepower conditions where it is not practical to use a motor driven device.

Other applications disclosed include decoupling the rotary speed of an alternator or generator from its prime driver so that the alternator or generator can operate at its best efficiency speed no matter the prime driver speed.

### BACKGROUND OF THE ART

For aviation platforms, the goal is to design the highest power density system while exceeding the required reliability standards. For aircraft pumps, thermal efficiency is especially important due to the added role of fuel and oil being heat sinks for various subsystems. Aircraft pumps are typically mounted to and driven by the accessory drive gearbox which in turn is driven by the high-pressure gas turbine engine spool. Since the accessory engine gearbox has a constant gear ratio, the aircraft pump input rotary speed is directly related to engine spool speed.

Pump efficiency is maximized when the fluid displacement of a pump matches the particular demand requirement of the engine and associated subsystems. To accomplish this, various attempts have been made to improve pump efficiency by employing variable displacement pumps coupled with various valving arrangements.

Today's variable displacement pumps typically vary the fluid pumped per revolution by varying the stroke of the pumping element, such as a piston in a piston pump or a vane in a vane pump. Another technique that is employed is a multi-stage pump that has the capability to “unload” or switch a stage on and off.

The fore-mentioned systems do improve pump thermal efficiency but at the expense of increased weight and cost. For instance, an actuation system is required to move a cam so that the stroke of a vane pump can be varied, and in a multi-stage pump, two sets of pumping elements are required as well as special valving to unload a stage. Additionally, when a pumping stage is unloaded the “windage” and “churning” energy losses are still present due to the higher than required pump input speed.

Embodiments disclosed include a variable speed drive that allows a high horsepower, gearbox driven pump to behave like a motor driven pump without the weight penalty induced by a high horsepower motor. This drive is capable of setting and maintaining the pump rotary speed independent of the external gearbox speed so that the pump can deliver the required flow displacement for any given flight condition. Other advantages include the capability to constantly operate an automotive alternator at its best efficiency speed no matter what the engine speed is. These and other advantages of the invention, as well as additional inventive features, will be apparent from the description of the invention provided herein.

### SUMMARY OF THE INVENTION

An electronically controlled variable speed drive consists of a compound planetary gear set, a motor, and an electronic controller. The drive is driven by an external drive, and depending on the application, it may contain either one or two output drive shafts. The variable speed drive is capable of continuously varying the gear ratio within a compound planetary gear set by applying an electronically controlled retarding torque to a motor. It is capable of achieving a 1:1 gear ratio to the maximum gear ratio determined by the number of teeth on the gears located within the compound planetary gear set.

In one aspect, the invention provides a means of electronically setting and controlling the output speed of the drive shaft(s). The speed controller electronics is arranged as a dynamic or regenerative braking system so that a retarding torque can be developed by the motor, whose rotor is attached to the compound planetary gear set output ring gear. If dynamic braking is off then the overall gear ratio is 1:1. If dynamic braking is on, then the output shaft with the sun gear rotates faster than the input drive speed and the output shaft attached to the compound planetary gear set output ring gear and thus the motor rotor rotates slower than the input drive speed. The microprocessor compares the required output speed against the measured output speed and adjusts the retarding torque accordingly. To insure that the sun gear never rotates slower than the input ring gear, a one way bearing helps to support the sun gear carrying output drive shaft.

In another aspect, the invention provides a means of transforming a fixed displacement pump into a variable displacement pump to provide flow on demand.

In yet another aspect, the invention provides a means of maintaining the constant speed of an alternator or generator no matter what the input drive speed is.

### BRIEF DESCRIPTION OF THE DRAWINGS

FIG. 1 is an exploded view of a variable speed drive assembly according to one embodiment of the invention;

FIG. 2 is an exploded view of a variable speed drive assembly according to one embodiment of the invention;

FIG. 3 is an exploded view of a compound planetary gear set according to one embodiment of the invention;

FIG. 4 is an exploded view of the installation of the motor rotor and a compound planetary gear set, according to one embodiment of the invention;

FIG. 5 is an isometric cross-section of a output drive shaft installed in said compound planetary gear set and showing a motor installed onto said compound planetary gear set, according to one embodiment of the invention;

FIG. 6 schematically depicts the variable speed drive driving a fixed displacement pump, according to one embodiment of the invention; and

FIG. 7 schematically depicts the variable speed drive driving a two stage fixed displacement pump, according to another embodiment of the invention;

While the invention will be described in connection with certain preferred embodiments, there is no intent to limit it to those embodiments. On the contrary, the intent is to cover all alternatives, modifications, and equivalents as included within the spirit and scope of the invention as defined by the appended claims.

### DETAILED DESCRIPTION OF THE INVENTION

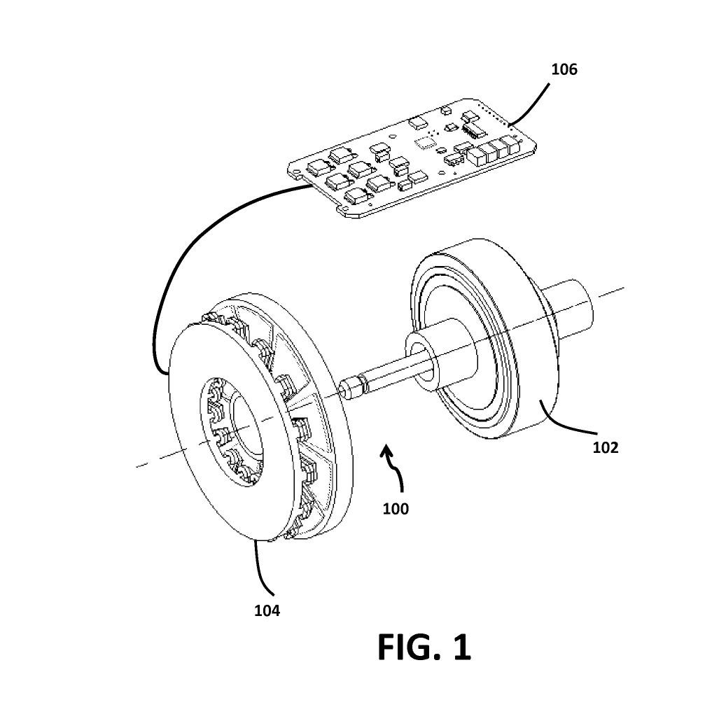

An exploded view of the variable speed drive 100 three main sub-assemblies according to one embodiment of the invention is shown in FIG. 1. In this embodiment, the variable speed drive 100 includes a compound planetary gear set 102, a motor 104, and an electronic control module 106, all of which may be contained within a common structure.

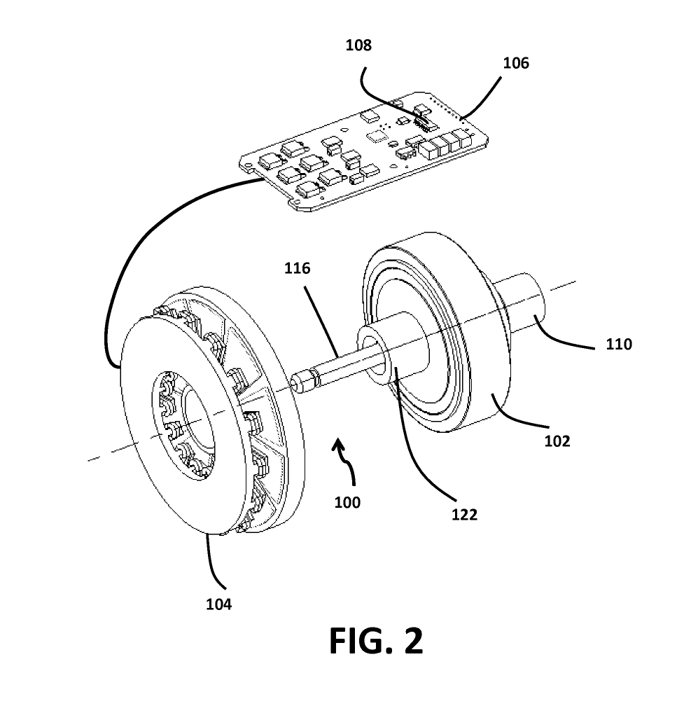

An exploded view depicting the variable speed drive 100 according to an embodiment of the invention is also shown in FIG. 2. An external drive connects to and drives internal ring gear 110, which is part of the compound planetary gear set 102 sub-assembly. Motor 104 connects to and is rotated by internal ring gear 122, which is part of the compound planetary gear set 102 subassembly. Output drive shaft 116, a part of the compound planetary gear set 102 sub-assembly, rotates at a speed determined by a gear ratio of the gear set 102. The voltage being produced by motor 104 rotating is electrically flowing through motor 104 windings and the electronic control module 106, which contains dynamic or regenerative braking circuitry and microprocessor 108. Microprocessor 108 monitors the speed of output drive shaft 116 against a speed demand input signal. Microprocessor 108 changes the speed of output drive shaft 116 by controlling the torque generating current electrically flowing through motor 104 windings. As motor 104 torque is varied, compound planetary gear set 102 overall gear ratio is also varied. Therefore, the speed ratio between internal ring gear 110 and output drive shaft 116 can be set by microprocessor 108.

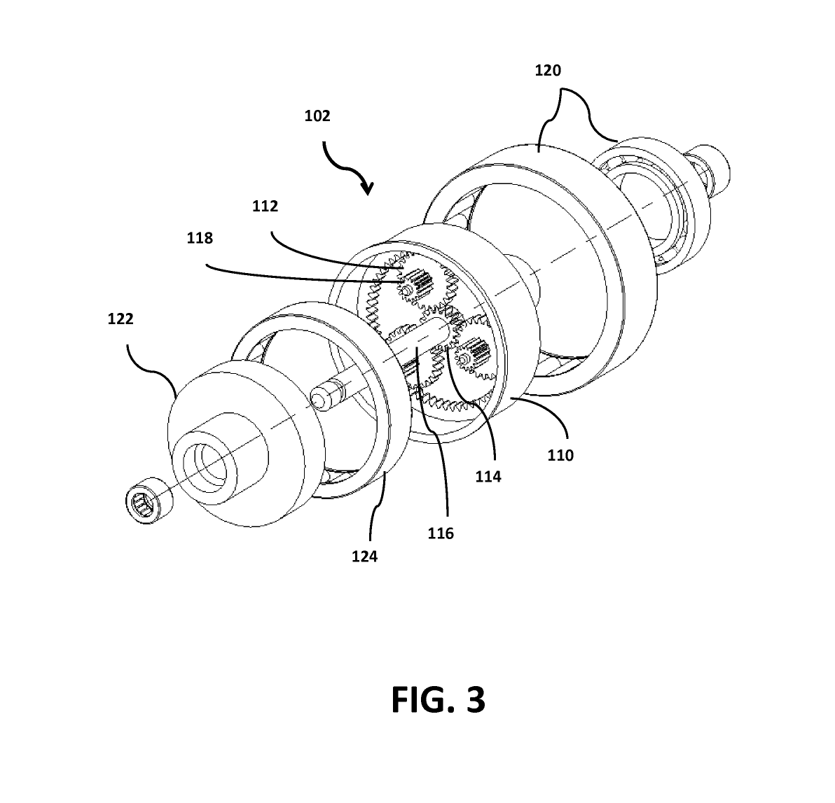

The compound planetary gear set 102 according to an embodiment of the invention is depicted in more detail in FIG. 3. The compound planetary gear set 102 includes an internal ring gear 110, which rotates on bearings 120 and engages with planetary gears 112 as gear set 102 is rotated by an external drive. Planetary gears 112 rotate the sun gear 114, which rotates the output drive shaft 116. Planetary gears 118 are formed integrally with or are rigidly attached to planetary gears 112 and rotate with such planetary gears 112 around sun gear 114. Planetary gears 118 in turn rotate internal ring gear 122, which is supported by bearing 124 and rigidly connects to motor 104.

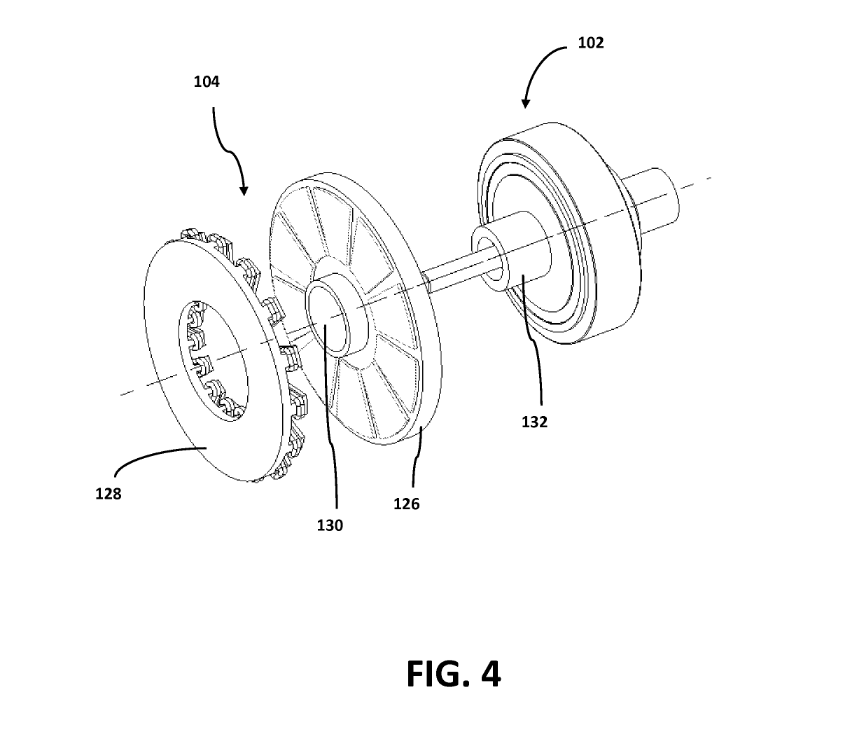

FIG. 4 shows the installation of the compound planetary gear set 102 and motor 104 according to an embodiment of the invention. Motor 104 consists of two sub-assemblies, a rotating rotor 126 and a stationary stator 128. The rotor 126 has a diameter 130 that fits onto and is located by internal ring gear 122 diameter 132.

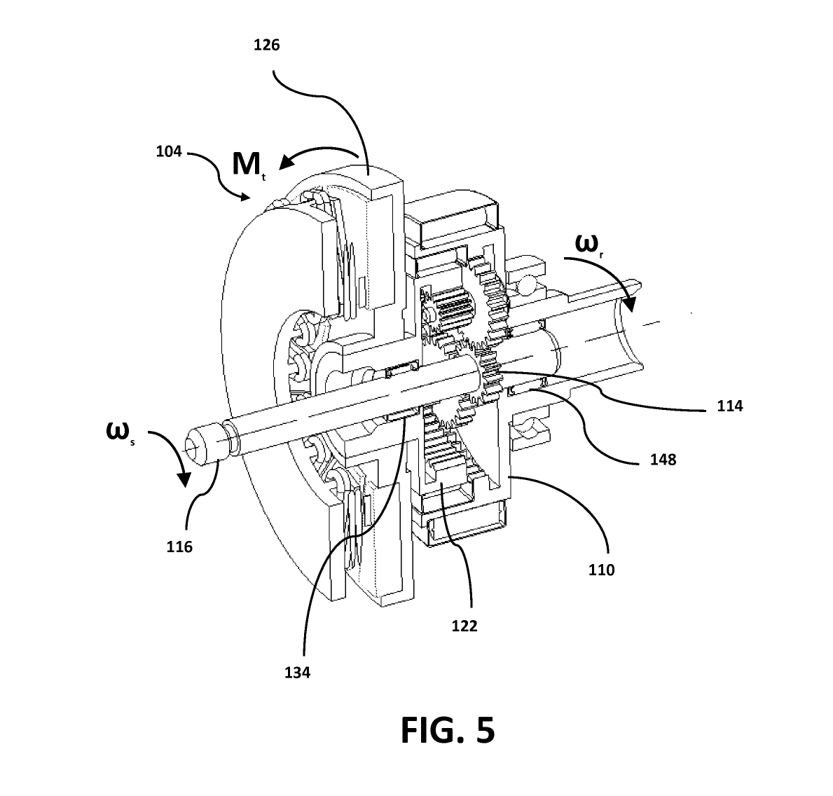

FIG. 5 illustrates a cross section depicting the rotational mechanics of the output drive shaft 116 according to one embodiment of the invention. The output drive shaft 116 along with the integral sun gear 114 are supported by rolling element bearing 134 and a one way bearing (anti-reverse bearing) 148. The one way bearing 148 transmits torque between the output drive shaft 116 and the internal ring gear 110 in one direction and while allowing free rotation in the opposite direction. This relationship insures that the output drive shaft 116 cannot rotate at a slower speed than the externally driven input internal ring gear 110. With rotor 126 attached to internal ring gear 122, when torque is applied by motor 104, internal ring gear 122 changes rotational speed, which then changes the rotational speed of output drive shaft 116. Therefore the gear ratio between the internal ring gear 110 and output drive shaft 116 can be varied and set by adjusting the torque on internal ring gear 122 via motor 104.

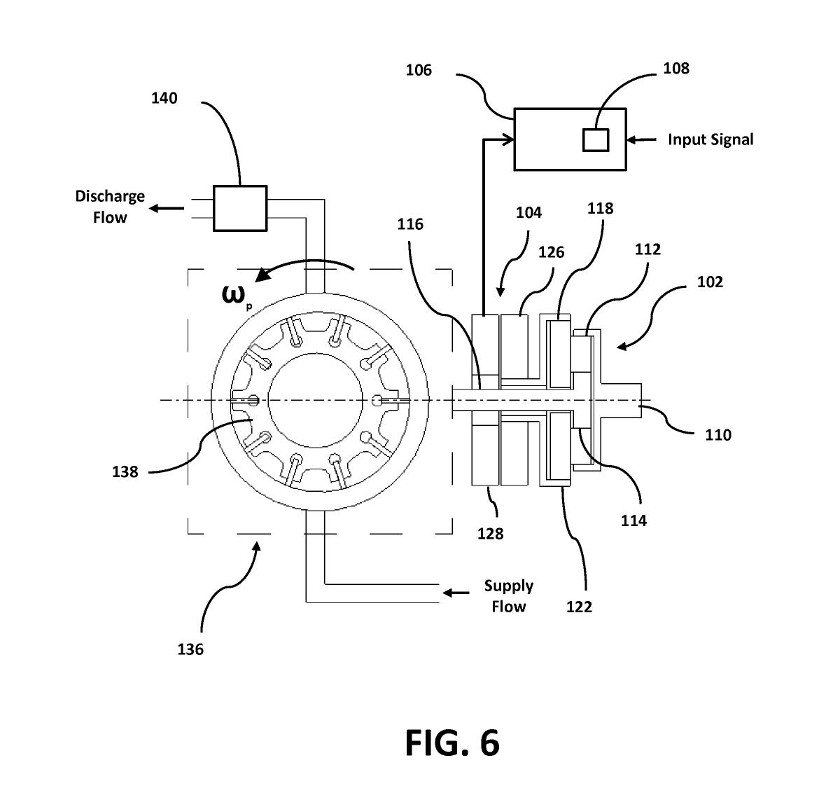

FIG. 6 schematically illustrates how a single stage fixed displacement pump 136 is transformed into a variable displacement pump according to one embodiment of the invention. Pumping element 138 is connected to and rotated by output drive shaft 116, which is integral to sun gear 114. With internal ring gear 110 driven by an external drive and rotating at a constant speed, an input signal that could represent required flow, is transmitted to microprocessor 108, which is located within electronic control module 106. Microprocessor 108 compares the measured flow signal from sensor 140 against the input signal and directs the voltage being generated by motor 104 through the electronic control module 106 dynamic braking circuit accordingly. If the discharge flow measured by sensor 140 is lower than required, then the current flowing through motor 104 is increased which in turn increases retarding torque. An increase in retarding torque increases the overall gear ratio in the compound planetary gear set 102 and therefore the rotary speed of pumping element 138 is increased. If supply flow is higher than required the rotary speed of pumping element 138 is decreased by decreasing motor 104 retarding toque.

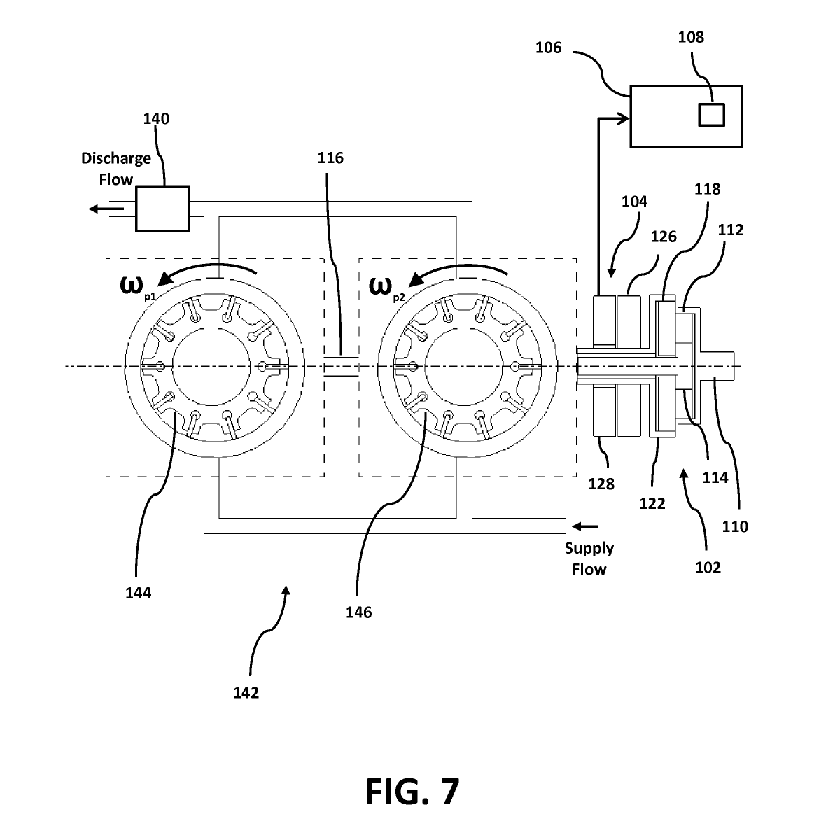

FIG. 7 schematically illustrates how a multi-stage fixed displacement pump 142 is transformed into a variable displacement pump according to one embodiment of the invention. Pumping element 144 is connected to and rotated by output drive shaft 116, which is integral to sun gear 114, and pumping element 146 is connected to and rotated by internal ring gear 122. When the retarding torque developed by motor 104 is increased by the electronic control module 106, the rotary speed of pumping element 144 increases and the rotary speed of pumping element 146 decreases. When the retarding torque developed by motor 104 is decreased by the electronic control module 106, the rotary speed of pumping element 144 decreases and the rotary speed of pumping element 146 increases. If dynamic braking is removed by the electronic control module 106, the rotary speed of pumping elements 146 and 144 are equal and equal the rotary speed of internal ring gear 110.

The maximum achievable gear ratio is determined by the compound planetary gear set 102 internal geometry.

The overall gear ratio in compound planetary gear set 102 is increased when retarding torque developed by motor 104 is increased.

The overall gear ratio in compound planetary gear set 102 is decreased when retarding torque developed by motor 104 is decreased.

When motor 104 retarding, torque is removed, the gear ratio between internal ring gear 110 and output drive shaft 116 is 1:1.

When motor 104 is rotating, the electronic control module 106 is receiving a voltage from motor 104 and a dynamic or regenerative braking circuit is utilized to control the amount of current available to motor 104.

The electronic control module 106 utilizes a closed loop control system to maintain a constant torque and therefore gear ratio.

Many variations may be made in the invention as shown and in its manner of use without departing from the principles of the invention as described herein and/or as claimed as our invention. Minor variations will not avoid the use of the invention.

I claim as my invention:

1. A variable speed drive for driving a device having at least one rotary element, the variable speed drive comprising: an compound planetary gear set driving said element via a shaft, a motor continuously varying the gear ratio of said compound planetary gear set, and a motor control comprising an electronic control module that receives an input signal and selectively retards the rotary speed of each of said at least one rotary element.

2. A variable speed drive as defined in claim 1, wherein the drive operates a common centerline mounted two stage device, each stage operating at different rotary speeds.

3. A variable speed drive as defined in claim 1, wherein the electronic control module signal sets the retarding torque developed by the motor that sets the rotary speed of each of said at least one element.

4. A variable speed drive as defined in claim 1, wherein the electronic control module is configured as one of a dynamic and a regenerative braking system that sets the retarding torque developed by the motor that sets the rotary speed of the at least one rotary element.

5. A variable speed drive as defined in claim 1, wherein the retarding torque developed by the motor sets the gear ratio of said compound planetary gear set.

6. A variable speed drive as defined in claim 1, wherein the drive comprises a compound planetary gear set, means for one input shaft to connect to an external input drive, and an output shaft driving an operating element.

7. A variable speed drive as defined in claim 1, wherein the output drive speed is adjusted by varying the torque developed by said motor to vary the gear ratio between the compound planetary gear sets.

8. A variable speed drive as defined in claim 1, wherein the output shaft operates at the same rotary speed (1:1 gear ratio) as the input shaft when both dynamic and regenerative braking is absent.

9. A variable speed drive as defined in claim 1, wherein the motor has a stationary stator affixed to a structure and a rotating rotor attached to the compound planetary gear set output shaft.

10. A variable speed drive as defined in claim 1, wherein the rotary speed of the rotor is controlled by said electronic control module.

11. A variable speed drive as defined in claim 1, wherein an external drive drives an internal ring gear causing planet gears cooperating therewith to orbit around a centrally-located sun gear which in-turn drives a secondary, outwardly located internal ring gear.

12. A variable speed drive as defined in claim 11, wherein the sun gear is driven by planet gears and in-turn drives an output shaft element.

13. A variable speed drive as defined in claim 11, wherein the secondary internal gear is directly coupled to a motor rotor and drives a second, selected element.

14. A variable speed drive as defined in claim 13, wherein spinning of the motor rotor generates a voltage proportional to its rotary speed.

15. A variable speed drive as defined in claim 14, wherein the path of the motor generated voltage is dictated by the speed control module.

16. A variable speed drive as defined in claim 15, wherein the speed control module contains power resistors means for determining and controlling the amount of current available to produce motor torque.
